(19) United States
(12) Patent Application Publication
(10) Pub. No.: US 2003/0074754 A1
(43) Pub. Date: Apr. 24, 2003

(54) Surface treatment tool

(76) Inventor: Clive Holden, Athelstone (AU)

Correspondence Address: David A. Jackson, KLAUBER & JACKSON, 4th Floor, 411 Hackensack Street, Hackensack, NJ, 07601, US

(21) Appl. No.: 10/313,503

(22) Filed: Dec. 6, 2002

Related U.S. Application Data
(63) Continuation of application No. PCT/AU01/00683, filed on Jun. 8, 2001.

(30) Foreign Application Priority Data
Jun. 9, 2000 (AU) PQ 8055
Jul. 19, 2000 (AU) PQ 8838

(51) Int. Cl. A46B 9/02; B05C 17/00

(52) U.S. Cl. 15/160; 15/210.1; 15/244.1

(57) ABSTRACT

A tool for providing treatment to an uneven surface such as for applying paint or for sanding. The uneven surface may be a latticework panel or a trellis structure. The tool has a base (1) with a planar first work surface (20) and an elongate protrusion (21) on the base providing a second work surface (21) substantially parallel to the first work surface. Both the work surfaces are covered with an appropriate coating such as a paint applying material (6). There may also be a third work surface between the other work surfaces normal to them.

### FIELD OF INVENTION

This invention relates to a surface treatment tool and in particular to a tool used to treat uneven surfaces.

### BACKGROUND OF THE INVENTION

The invention will be discussed in relation to its application for treatment of surfaces including sanding and painting but is not restricted to those treatments.

The uneven surfaces to which this invention is particularly directed are those found on latticework panels, picket fences and the like, but again the invention is not restricted to this particular application but can be used for other applications where uneven surfaces are involved.

Surfaces to be painted need to be suitably prepared. Typically surfaces not only need to be cleaned but may also require some smoothing or abrading generally achieved by sanding. A difficulty arises when one has to prepare and paint uneven surfaces such as those found on picket fences and trellises where there is not only a single planar surface to prepare and coat but where there may be side and edge surfaces in different planes which need to be prepared and painted. The sanding of these surfaces and painting by conventional means can be time-consuming and difficult.

It is an object of this invention to provide a tool which can be used to prepare and paint uneven surfaces that overcomes at least some of the above-mentioned problems or provides the public with a useful alternative.

### SUMMARY OF THE INVENTION

In one form therefore the invention is said to reside in a surface treatment tool adapted for the treatment of at least two adjacent parallel surfaces, the tool having a first substantially planar treatment surface and a second planar treatment surface spaced apart from the first surface and being substantially parallel to the first surface,

Preferably each of the treatment surfaces is adapted for the application of paint. Alternatively each of the treatment surfaces may be abrasive surfaces for the smoothing of the adjacent parallel surfaces.

The surface treatment tool according to this invention may further include a third treatment surface between the first surface and the second surface. This third treatment surface may be normal to the planes of the first and second treatment surfaces.

In one preferred form of the invention the second surface may be on a protrusion extending from the first surface. The protrusion may be formed from a resilient material.

The protrusion may have substantially parallel sides and a tapered leading end.

In one embodiment of the invention the first surface may be substantially rectangular and in another embodiment the first surface may be substantially rectangular but having one end thereof tapered from its sides.

There may be a handle extending from the rear surface of the tool. Preferably the handle can be removed and repositioned at different angles to assist with manipulation into difficult comers.

In an alternative form the invention is said to reside in a tool for applying paint to a lattice or trellis structure, the tool having a base with a planar first work surface and an elongate protrusion on the base providing a second work surface substantially parallel to the first work surface, both the first work surface and the second work surface being covered with a paint applying material.

There may be further included a third work elongate protrusion and the third work surface being covered with a paint applying material. Preferably a third work surface is provided on both sides of the elongate protrusion.

The third work surface may be substantially normal to the first work surface.

The elongate protrusion may be formed from a resilient material such as a closed cell foam.

Preferably the elongate protrusion has a tapered leading edge.

The tool may have a tapered leading edge to enable it to be worked into corners.

The tool may have a handle extending from a rear surface of the base. The handle may be removable and able to be replaced in an opposite direction.

The paint applying material may be comprised of bristles. Alternatively the paint applying material may be a fibrous material known in the art as lambswool. Alternatively the paint applying material may be an open cell foam material.

This then generally describes the invention but to assist with understanding reference will now be made to the accompanying drawings which show preferred embodiments of the invention.

### In the drawings:

FIG. 1 shows a first embodiment of a paint application tool according to the invention;

FIG. 2 shows an alternative embodiment of a paint application tool according to the invention;

FIG. 3 shows an embodiment of the paint application tool shown in FIG. 1 with the paint applying material not shown to show the internal construction of the operative surfaces;

FIG. 4 shows the embodiment shown in FIG. 3 with the paint applying material fixed to it;

FIG. 5 shows a cross-section of the paint application tool along the line 5-5′ of FIG. 1;

FIG. 6 shows the operation of the tool to apply paint to a latticework panel;

FIG. 7 shows the use of the paint, application tool according to this invention for application of paint to a picket fence;

FIG. 8 shows the use of the paint application tool of the present invention to apply paint to a square latticework panel;

FIG. 9 shows the use of the paint application tool shown in FIG. 1 to apply paint to a diagonal latticework panel; and

FIG. 10 shows an alternative embodiment of the paint application tool according to this invention in which the protrusion may be positioned at a variety of positions and more than one protrusion may be used.

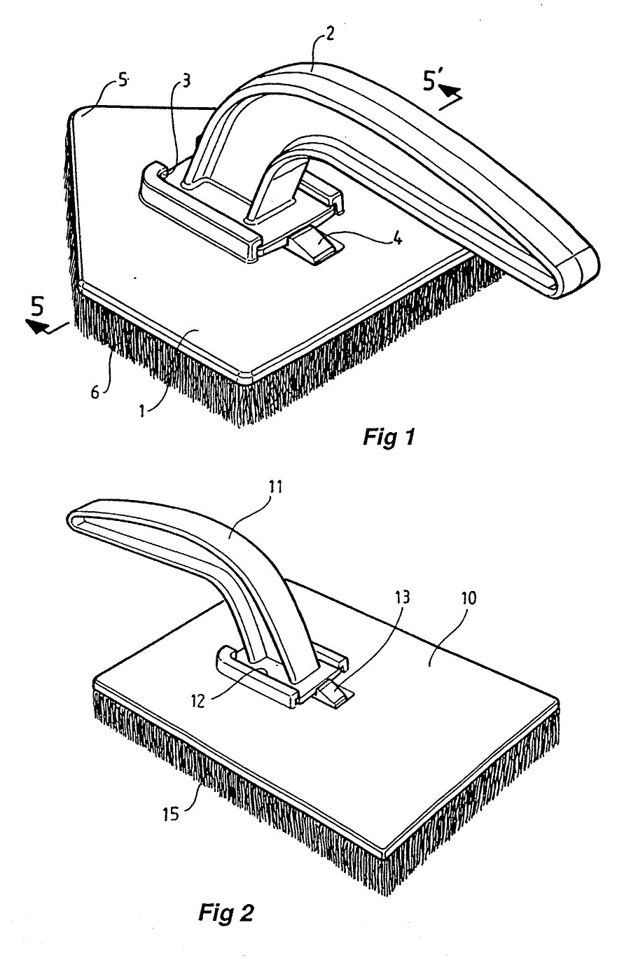

Now looking more closely at the drawings and in particular the embodiment shown in FIG. 1, it will be seen that the paint application tool according to this invention has a substantially planar base 1 with a handle 2 mounted into a socket 3 on the base. A spring clip 4 retains the handle in the socket. The handle can be removed from the base by pressing down on the spring clip 4 and sliding the handle from the socket. The handle can be replaced extending in the opposite direction to assist with manipulation of the tool into difficult comers.

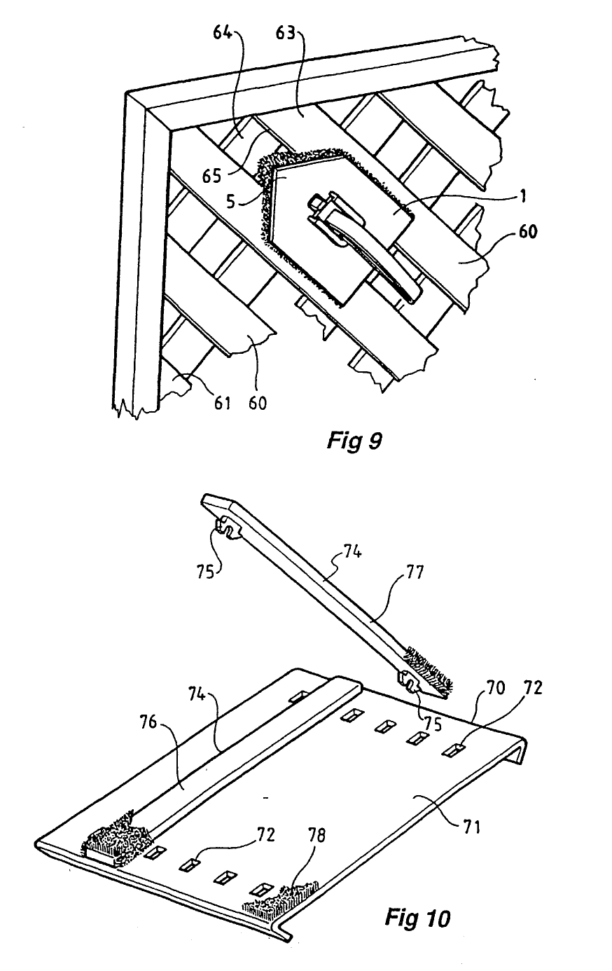

The base is substantially rectangular with a tapered front end 5. The tapered front end allows the paint application tool according to this invention to be worked into corners as will be particularly discussed with respect to FIG. 9.

On a front surface of the paint application tool are positioned paint application bristles or hairs 6. The bristles or hairs are adapted to retain paint in a known manner.

FIG. 2 shows an alternative embodiment of the paint application tool according to the invention. In this case the base 10 is substantially rectangular and the handle 11 is mounted into a socket 12 again with a spring clip 13 so the handle can be repositioned to face the opposite direction. The operative surface of the paint application tool has hairs or bristles 15.

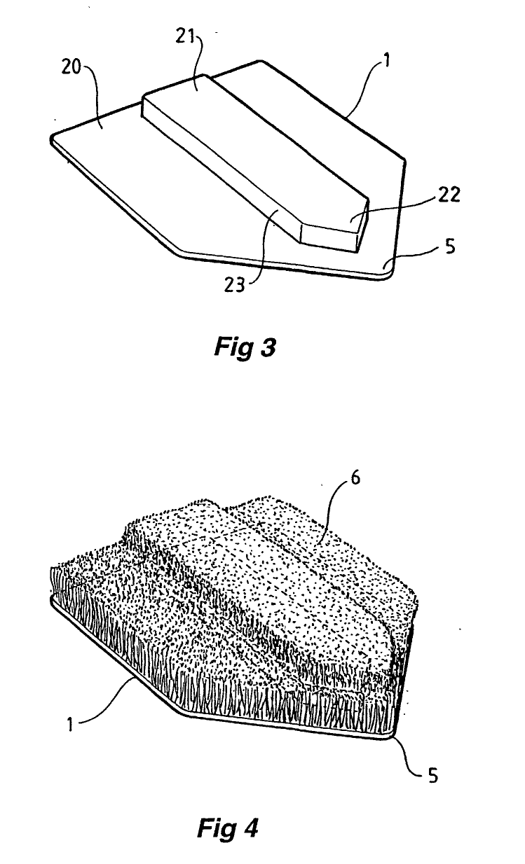

FIGS. 3 and 4 show the operative front surface of the paint application tool shown in FIG. 1 but FIG. 3 has the paint application bristles or hairs omitted to show the internal construction of the front surface. The base 1 has a planar working surface 20 with an elongate protrusion 21 on the surface 20. The elongate protrusion has a tapered leading end 22 which substantially aligns with the tapered end 5 of the base 1. The elongate protrusion is made from a resilient material such as a closed cell foam that may be fastened to the base by adhesive or similar means. The protrusion has sides 25.

As shown in FIG. 4 the entire front surface including the protrusion is coated with bristles or hair 6.

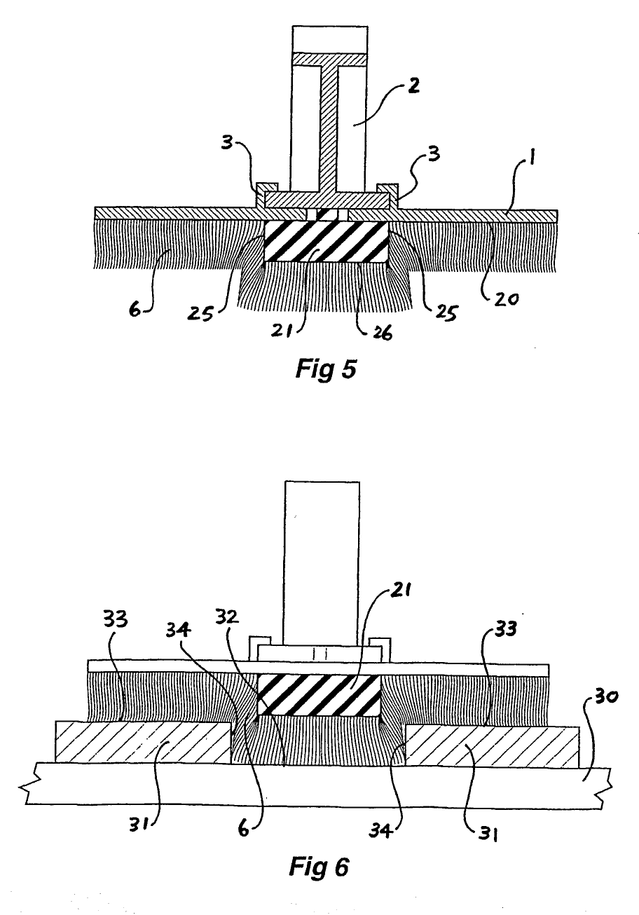

FIG. 5 shows a cross-sectional view through the lines 5-5 in FIG. 1. It will be noted that the hairs or bristles 6 affixed to the surface 20 of the base 1 also extend to the sides 25 of the protrusion 21 and extend over the surface 26 of the protrusion 21.

FIG. 6 shows the use of the paint application tool of the present invention to apply paint to a wooden latticework panel. The wooden latticework panel comprises transverse laths 30 spaced at intervals and longitudinal laths 31 spaced at intervals on the transverse laths 30. The depth of the protrusion 21 is substantially the same depth as the depths of the laths 31 and narrower than the spacing between the adjacent laths 31. The bristles or hairs 6 can therefore engage against the adjacent parallel surfaces being the surface 32 on the lath 30 and the surfaces 33 on the laths 31 as well as the side surfaces 34 on the laths 31.

By this means all of the adjacent surfaces on the lattice can be painted at once and then by using the paint application tool of the present invention on the opposite side of the lattice the other sides of the laths can be painted.

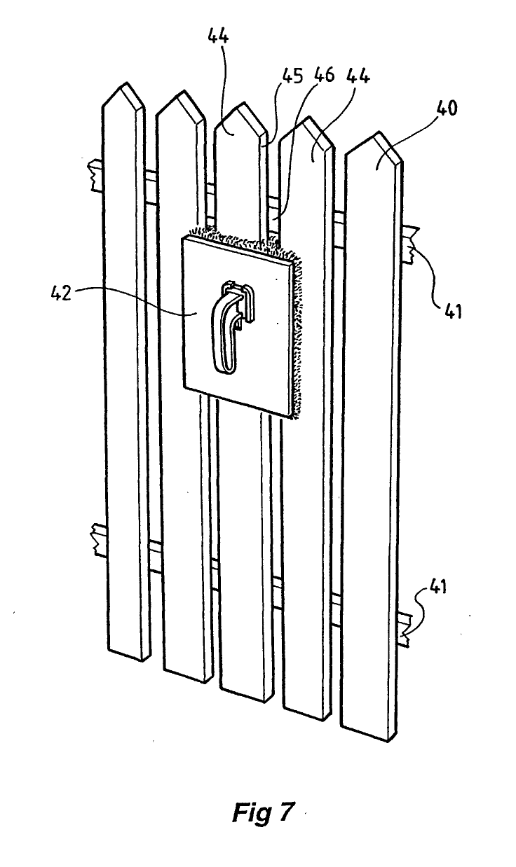

FIG. 7 shows the use of a paint application tool according to the present invention for the application of paint to a picket fence. The fence comprises a number of pickets 40 mounted onto upper and lower longitudinal beams 41.

The paint application tool 42 according to this embodiment has deeper and narrower protrusions so that the protrusions fit between the palings 40 so that with one pass of the tool the front surfaces 44 of adjacent pickets are painted as well as the side surfaces 45 of adjacent pickets and the surface 46 of the beams 41. There may be more than one protrusion on the paint application tool.

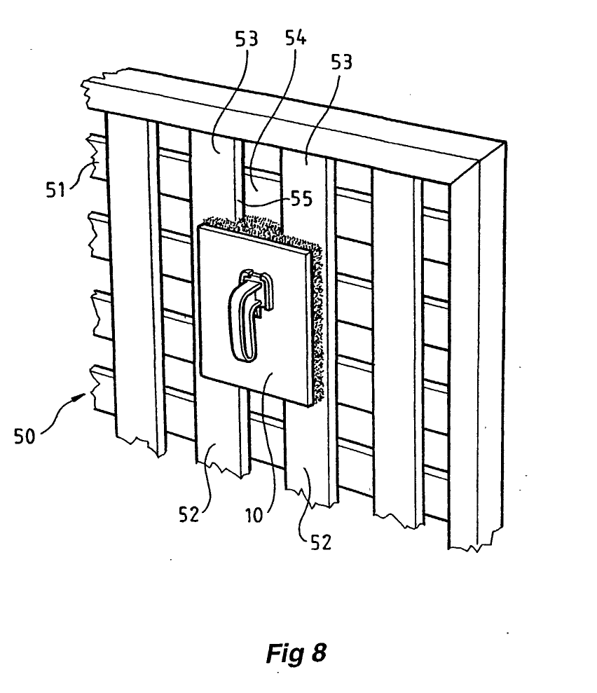

FIG. 8 shows the use of the paint applicator tool shown in FIG. 2 to square style latticework panel.

The latticework panel 50 generally comprises horizontal laths 51 and vertical laths 52. The applicator tool 10 enables the surfaces 53 on adjacent vertical laths 52 to be painted as well as the surface 54 of the horizontal lath 51 between the laths 52 to be painted as well as the side edges 55 of the vertical laths 52. By this arrangement a considerable time saving in painting latticework panels can be achieved.

FIG. 9 shows the use of the paint applicator shown in FIG. 1 for painting diagonal latticework. The diagonal latticework consists of a first set of laths 60 at one angle and a second set of laths 61 substantially at right angles to the first set. The paint applicator 1 has a tapered leading edge 5 so that the applicator can paint right into the corners of the diagonal latticework. Once again the applicator of the present invention is adapted to paint onto the parallel but spaced apart surfaces 63 and 64 as well as the side edges 65 of the laths 60.

FIG. 10 shows an alternative embodiment of the paint applicator according to this invention. In this embodiment the base 70 is substantially planar with a planar front surface 71. The base 70 has two rows of apertures 72 The protrusions 74 are formed as pieces which can be fastened to the base 70 by spigots 75 on the protrusions fixing into the aperture 71 on the base. More than one protrusion may be mounted to the base 70 and there can be a variety of depths of protrusions 74. Both the front surface 71 and the front surfaces 76 of the protrusion 74 as well as the side edges 77 of the protrusion may be coated with bristles 78. For clarity not all the bristles have been shown in this drawing.

Throughout this specification various indications have been given as to the scope of the invention but the invention is not limited to any one of these but may reside in two or more of these combined together. The examples are given for illustration only and not for limitation.

The claims defining the invention are as follows:

1. A surface treatment tool adapted for the treatment of at least two adjacent parallel surfaces, the tool having a first substantially planar treatment surface and a second planar treatment surface spaced apart from the first surface and being substantially parallel to the first surface, wherein each of the treatment surfaces is adapted for the application of paint.

2. A surface treatment tool as in claim 1 further including a third treatment surface between the first surface and the second surface and the third treatment surface is also adapted for the application of paint.

3. A surface treatment tool as in claim 2 wherein the third treatment surface is normal to the planes of the first and second treatment surfaces.

4. A surface treatment tool as in claim 1 wherein the second surface is on a protrusion extending from the first surface.

5. A surface treatment tool as in claim 4 wherein the protrusion is formed from a resilient material.

6. A surface treatment tool as in claim 4 wherein the protrusion has substantially parallel sides and a tapered leading edge.

7. A surface treatment tool as in claim 1 wherein the first surface is substantially rectangular.

8. A surface treatment tool as in claim 9 wherein the rectangular surface has one end thereof tapered.

9. A surface treatment tool as in claim 1 including a handle extending from the rear surface of the tool.

10. A surface treatment tool as in claim 11 where the handle is repositionable.

11. A tool for applying paint to a latticework panel or trellis structure, the tool having a base with a planar first work surface, an elongate protrusion on the base providing a second work surface substantially parallel to the first work surface, both the first work surface and the second work surface being covered with a paint applying material.

12. A tool as in claim 11 further including a third work surface on at least one edge of the elongate protrusion, the third work surface being covered with a paint applying material.

13. A tool as in claim 12 wherein the third work surface is substantially normal to the first work surface.

14. A tool as in claim 11 wherein the elongate protrusion is formed from a resilient material.

15. A tool as in claim 11 wherein the paint applying material is comprised of bristles.

16. A tool as in claim 11 wherein the paint applying material is comprised of lambswool.

17. A tool as in claim 11 wherein the paint applying material is an absorbent open cell foam.

18. A tool as in claim 11 wherein the elongate protrusion has a tapered leading edge.

19. A tool as in claim 11 where the base has a tapered leading edge.

20. A tool as in claim 11 having a handle extending from a rear surface of the base.

21. A tool as in claim 20 wherein the handle is removable and able to be replaced extending in an opposite direction.
